(19) United States
(12) Patent Application Publication
(10) Pub. No.: US 2020/0037403 A1
(43) Pub. Date: Jan. 30, 2020

(54) MAGNETIC INDUCTION STYLE FURNACE OR HEAT PUMP OR MAGNETIC REFRIGERATOR HAVING ELECTROMAGNETIC CONTROLLER FUNCTIONALITY AND VARYING ROTATING DISK PACKAGE CONDUCTOR PLATE CONFIGURATIONS

(71) Applicant: Heat X, LLC, Auburn Hills, MI (US)

(72) Inventor: Miguel A. Linares, Bloomfield Hills, MI (US)

(73) Assignee: Heat X, LLC, Auburn Hills, MI (US)

(21) Appl. No.: 16/535,331

(22) Filed: Aug. 8, 2019

Related U.S. Application Data
(63) Continuation-in-part of application No. 16/519,437, filed on Jul. 23, 2019.
(60) Provisional application No. 62/703,128, filed on Jul. 25, 2018.
(60) Provisional application No. 62/765,131, filed on Aug. 16, 2018.

(51) Int. Cl. H05B 6/06; H05B 6/10; F25B 21/00

(52) U.S. Cl. CPC H05B 6/06; F25B 21/00; H05B 6/108; H05B 6/109

(57) ABSTRACT

An electromagnetic induction system for providing either heating or cooling. A sleeve shaped component extends within the housing and supports a plurality of spaced apart and radially extending electro-magnetic plates. An elongated conductive component is rotatably supported about the sleeve support and incorporates a plurality of linearly spaced apart and radially projecting conductive plates which alternate with the electro-magnetic plates. A motor rotates the conductive component such that rotation of the conductive plates results in the creation of an oscillating magnetic field for conditioning of the fluid by either heating or cooling of the fluid. A controller adjusts an intensity of the magnetic fields to adjust a level of conditioning of the fluid flow which is communicated via the conductive component through an outlet of the housing.

### CROSS REFERENCE TO RELATED APPLICATIONS

The present application is a continuation in part of U.S. Ser. No. 16/519,437 filed Jul. 23, 2019. The present application also claims the priority of provisional application U.S. Ser. No. 62/765,131 filed Aug. 16, 2018.

### FIELD OF THE INVENTION

The present invention relates generally to an electromagnetic or magnetic induction heating assembly. More specifically, the present invention discloses, in an illustrated embodiment, a magnetic or electromagnetic induction furnace or heat pump which incorporates a combination circular/rotary and outer vane shaped electrically conductive plate integrated into a central elongated and rotating element for simultaneously inductive heating the proximate located magnetic plates as well as redirecting the heated air out of the furnace cabinet. A controller is provided for adjusting the strength (or turning on and off) of a plurality of electromagnets secured to each of the magnetic plates and in order to switch the furnace between a thermostat heat adjustable mode or a non-heating fan mode in which the electromagnets are deactivated and the generation of heat prevented from occurring. When conductive plates are demagnetized the fluid flow will absorb heat from the fluid generating cold and reverting the functionality of the device into a magnetic refrigerator or magnetic air conditioner. The individual rotating conductor plates incorporated into the rotating element can also include varying interior chamber designs with different combination airflow or fluid flow configurations in order to provide the combined aspects of inductive heating (owing to rotation relative to the magnetic plates) and concurrent air redirection through the furnace outlet. Other variants include applications of the present technology reconfigured as a magnetic heat pump (MHG), such utilizing a magneto-caloric effect (MCE), for providing either of heating or cooling properties resulting from the magnetization (heat) or demagnetization (cold) cycles.

### BACKGROUND OF THE INVENTION

The phenomena of induction heating is well known in the prior art by which heat is generated in an electrically conductive object by the generation of eddy currents. The typical induction heater includes an electronic oscillator which passes a high frequency alternating current through an electromagnet. The eddy currents flowing through the resistance of the material in turn heat it. Put another way, the eddy currents result in a high-frequency oscillating magnetic field which causes the magnet's polarity to switch back and forth at a high-enough rate to produce heat as byproduct of friction.

One known example of a prior art induction heating system is taught by the electromagnetic induction air heater of Garza, US 2011/0215089, which includes a conductive element, a driver coupled to the conductive element, an induction element positioned close to the conductive element, and a power supply coupled to the induction element and the driver. Specifically, the driver applies an angular velocity to the rotate the conductive element about a rotational axis. The power supply provides electric current to the induction element to generate a magnetic field about the induction element such that the conductive element heats as it rotates within the magnetic field to transfer heat to warm the cold air flow streams. The cold air flow streams are circulated about the surface of the conductive element and directed by the moving conductive element to generate warm air flow streams from the conductive element.

Also referenced is the centrifugal magnetic heating device of Hsu 2013/0062340 which teaches a power receiving mechanism and a heat generator. The power receiving mechanism further includes a vane set and a transmission module. The heat generator connected with the transmission module further includes a centrifugal mechanism connected to the transmission module, a plurality of bases furnished on the centrifugal mechanism, a plurality of magnets furnished on the bases individually, and at least one conductive member corresponding in positions to the magnets. The vane set is driven by nature flows so as to drives the bases synchronically with the magnets through the transmission module, such that the magnets can rotate relative to the conductive member and thereby cause the conductive member to generate heat.

### SUMMARY OF THE PRESENT INVENTION

The present invention discloses, without limitation, an electromagnetic or magnetic induction heating system, this including each of a housing having a fluid inlet (can be an air or liquid fluid either hot or cold), a sleeve shaped support extending within the housing, and a plurality of spaced apart magnetic or electromagnetic plates, each of which can include an individual sub-plurality of electro-magnets, communicated with the air or other fluid inlet, the plates extending radially from the sleeve support.

An elongated conductive component is rotatably supported about the sleeve support, the conductive component incorporating a plurality of linearly spaced apart and radially projecting conductive plates which alternate with the axially spaced and radially supported electro-magnetic plates. A motor rotates the conductive component such that rotation of the conductive plates relative to the electro-magnetic plates results in the creation of an oscillating magnetic field for conditioning of the fluid by either heating or cooling of the fluid.

A controller adjusts an intensity of the magnetic fields in order to adjust a level of conditioning of the airflow or fluid flow produced by rotation of the conductive component. The conductive component, via its rotation, communicates the conditioned fluid through an outlet of the housing.

A shaft extends from the motor to the conductive component and is configured to dissipate heat generated within the conductive component at a mounting location with the shaft. In one non-limiting configuration the shaft is configured to induce a heat dissipating airflow through the mounting location to an external location of the housing.

In another configuration, the shaft includes a grid of air passageway inducing and intersecting radial and axial channels. In a further configuration, the shaft alternatively exhibits a spiraling pattern. A still further configuration includes the shaft having a squirrel fan arrangement with a plurality of axial extending louvers within the mounting location.

Additional features include each of the conductive plates being arranged as a pair of opposing plates assembled into a disk package and defining an interior airflow or fluid flow influencing an outwardly spiraling pattern. The conductive plates can further include an outer circumferential array of channeling and redirecting vanes for pushing the inductive heated or cooled air or fluid through the fluid outlet. A second and inner circumferential array of channeling and redirecting vanes are provided for pushing the inductive heated air through from the inlet to the outer array of redirecting vanes.

Other features include brackets extending from the sleeve to end mounting locations within said housing, a cylindrical outer wall extending between the mounting locations to define an outer cylindrical chamber surrounding the electro-magnetic plates. The conductive component further includes end walls and an interconnecting second cylindrical wall interconnecting each of the conductive plates and extending around the electro-magnetic plates to define an inner cylindrical chamber within the outer cylindrical chamber.

A thermostat is provided in communication with the controller and operates in a first mode for adjusting the intensity of the electro-magnetic fields, with the controller operating in a second mode to turn the electro-magnets off in order to operate in a fan mode. When conductive plates are demagnetized the fluid flow will absorb heat from the fluid generating cold and will operate as magnetic refrigerator or magnetic air conditioner.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective cutaway of the electromagnetic or magnetic induction furnace or heat pump according to a first embodiment and including a fixed axial extending sleeve with open interior channel and supporting a plurality of spaced magnetic plates, each of which supporting a circumferential array of electromagnets which are operated by a controller, an elongated conductive component rotatably supported about the sleeve, the conductive component incorporating a plurality of linearly spaced apart and radially projecting circular plates which alternate with the axially spaced and radially supported magnetic plates/electromagnets so that, upon rotation the conductive plates, each provides the combined features of both inductive electromagnetic heating of the magnets or electromagnets as well as channeling the ambient heated air between the magnetic plates and conductive plates for delivery through an outlet orifice in the furnace cabinet;

FIGS. 2-2E illustrate a variety of motor shaft configurations at an interface location between the shaft and axial support location established within the conductor plate subassembly, the shaft configurations each exhibiting linear air movement properties in order to assist in dissipating heat generated within the furnace at the shaft support location away from the internally positioned motor;

FIG. 3 is a cutaway taken along line 3-3 of FIG. 1 and illustrating an interior surface profile of a selective conductive plate including an inner cold air delivery port in proximity to outwardly spiraling portions in a multiple flute configuration, this in combination with outer channeling and redirecting vanes for pushing the inductive heated air generated by the rotating conductive plate heating the proximately located magnetic plates upwardly and out through the top of the cabinet;

FIG. 3A is a further radial cutaway illustrating in perspective a half section of an assembly of a package assembly of conductor plates and better showing the interior package space for concurrently inductive heating or cooling and outwardly directing the air;

FIGS. 4-4A are a pair of cutaway views corresponding to FIGS. 3-3A of a further variant of conductor plate and assembled disk package exhibiting a radially spiraling double flute configuration;

FIGS. 5-5A are a pair of cutaway views corresponding to FIGS. 3-3A of another variant of conductor plate and assembled disk package exhibiting a baffled heat chamber configuration;

FIGS. 6-6A are a pair of cutaway views corresponding to FIGS. 3-3A of a still further variant of conductor plate exhibiting inner and outer radially spaced circumferential arrangements of redirecting vanes; and

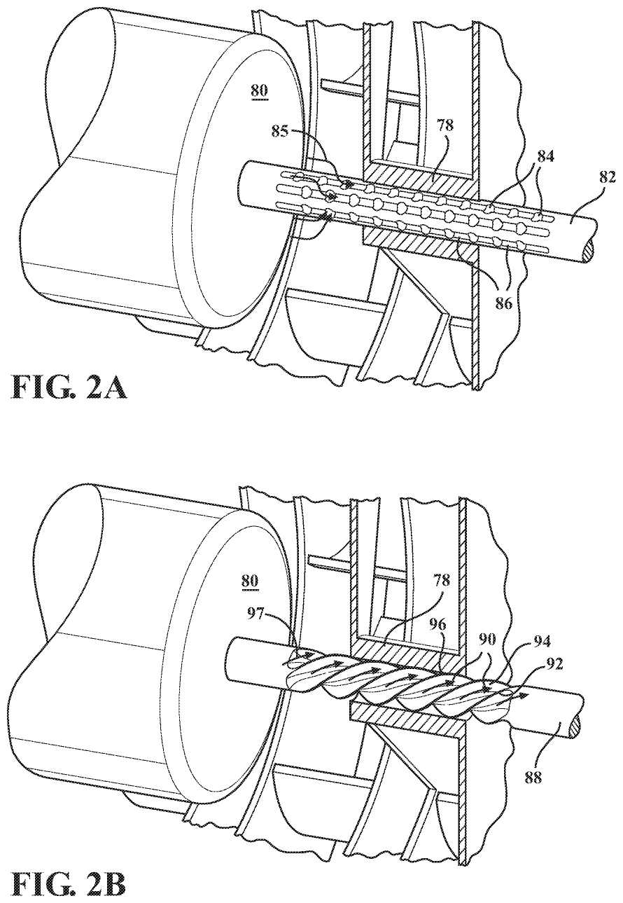

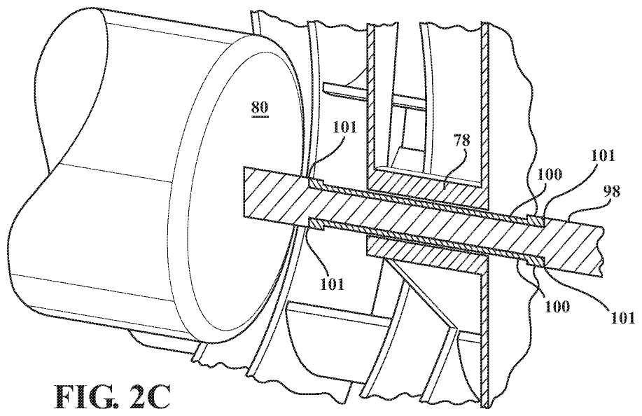

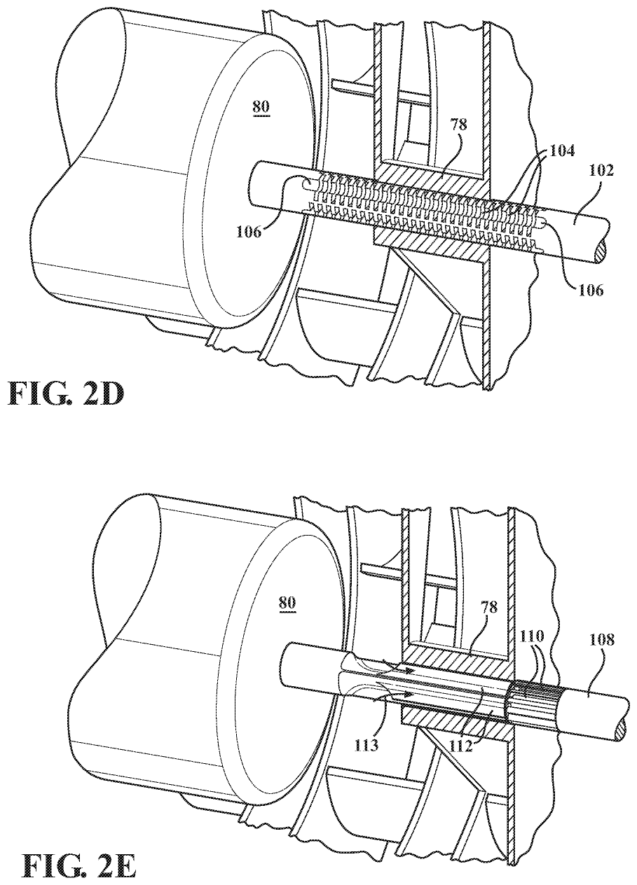

FIGS. 2-A-1, 2-B-1, 2-D-1 and 2-E-1 correspond to FIGS. 2A, 2B, 2D and 2E and illustrate enlargements of the heat dissipation motor shaft profiles for assisting in dissipating heat away from the interior motor.

### DETAILED DESCRIPTION OF THE PREFERRED EMBODIMENTS

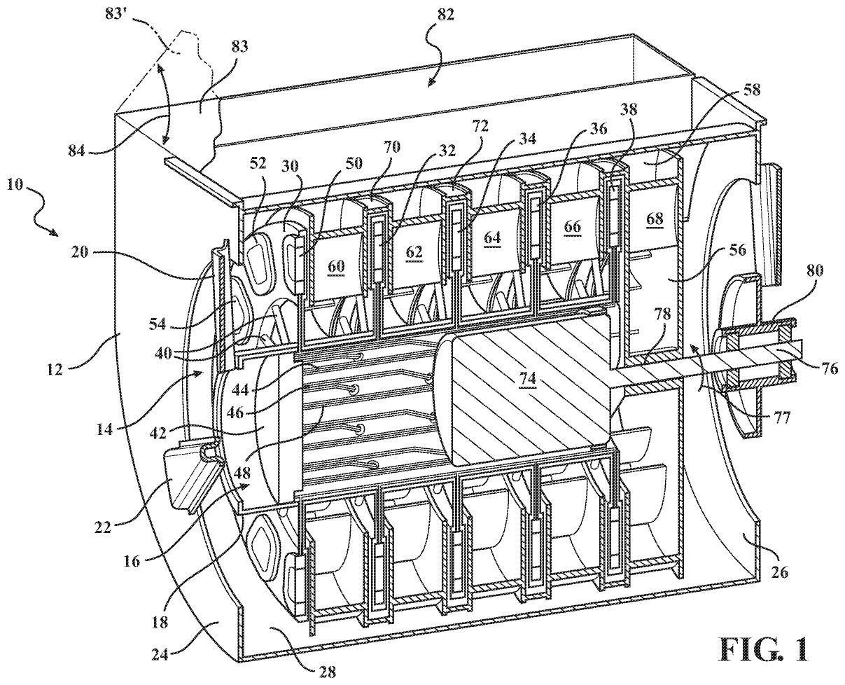

As previously described, the present invention discloses a magnetic or electromagnetic induction system for providing either of heating or cooling of a conditional fluid flow. In the non-limiting illustrated embodiment, the present invention further discloses a magnetic induction furnace, illustrated at 10 in FIG. 1, and which incorporates a combination of a plurality of linearly spaced, circular/rotary and outer vane shaped electrically conductive plates, these integrated into a central elongated and rotating element in alternating fashion with a plurality of proximate located magnetic plates, so that magnetic fields generated between the inter-rotating pluralities of plates result.

As will be further described in detail, the conductive plate geometry concurrently redirects the conditioned (heated or cooled) fluid out of the furnace cabinet. The fluid in the illustrated embodiment is further shown as an airflow however the invention also contemplates utilizing other gases or liquids as heat transfer mediums according to a desired assembly for convecting or conducting the inductive conditioned fluid flow to a suitable outlet.

Referring initially to FIG. 1, a perspective cutaway is shown of the electromagnetic induction furnace according to the non-limiting illustrated embodiment and which can include any type of housing, such as any cylindrical, rectangular or three dimensional shaped cabinet 12 defining a fluid inlet (for purposes of the illustrated embodiment being an ambient air inlet location at location 14 accounting for the cutaway depiction of the cabinet shown). An interior extending channel (see as generally referenced at 16) is defined by a circular inner perimeter which defines an axial extending support 18 within the interior of the cabinet.

The central support is fixedly mounted in the variant of FIG. 1 by brackets (see at 20 and 22) extending from the inner sleeve support 18 to outer mounting locations (see opposite end mounting plates 24 and 26 and outer cylindrical enclosure wall 28 which defines in this instance a cylindrical interior chamber within the cabinet 12). A plurality of spaced apart electromagnetic plates are depicted in one non-limiting arrangement at 30, 32, 34, 36 and 38, these arranged in axially spaced apart fashion and extending radially outwardly from the fixedly supported central sleeve 18.

It is further understood, without limitation, that the electromagnetic plates can be solid or can include an outermost disk portion from which extend radial rib supports as further shown at 40 for selected plate 30). Additional non-limiting embodiments of the present invention further contemplate substituting the electromagnetic plates with magnetic plates (such as configured from rare earth materials).

A controller 42 is located within the furnace housing (such as in the illustrated embodiment being located within the central sleeve 18). A plurality of wiring connections, see at 44, 46, 48, et seq., extend from the controller 42 both along the inner sleeve support 18 and radially outwardly along the extending rib supports 40 and connect to individual pluralities of electromagnets arranged around a circumference of each plate, and as shown at 50, 52, 54, et seq. for selected magnetic plate 30.

A thermostat input of conventional design is connected to the controller 42 (such as wired or wirelessly connected) and can be programmed or adjusted in order control the intensity of the magnetic fields induced into the individual pluralities of electromagnets, and which in turn varies the intensity of the inductive heat generated by the oscillating field created between the alternating pluralities of conductor plates and electro-magnetic plates. The controller can also deactivate (turn off) the electromagnets incorporated into the electromagnetic plates in order to operate the furnace in a fan mode, and without any inductive heat being generated between the rotating and airflow redirecting conductor plates and the alternating array of electromagnetic plates.

As is further understood, alternative assemblies and applications of the present invention further envision integrating with any known type of external air conditioner or other refrigeration device while engaged in the fan mode, as well as the ability to contribute to a magnetic refrigeration operation during demagnetization. This further contemplates combining ambient air or other fluid along with a further chilled air inlet source (such as associated with an outside AC compressor), this further provided through any of separate or combined fluid flows, and in order to vary the output fluid flow properties from the housing.

FIG. 1 also illustrates an elongated conductive component (also partially depicted in cutaway) including an elongated body rotatably supported about the sleeve 18 and between the electromagnetic plates 30-38. The conductive component defines a further cylindrical chamber (see selected end wall 56 not cutaway and outer connecting enclosure defining wall 58, also termed a second cylindrical wall interconnecting each of a plurality of individual conductive plates shown at 60, 62, 64, 66 and 68, and which are arranged in alternating fashion with the electromagnetic plates 30, 32, 34, 36 and 38. The enclosure defining wall 58 interconnecting the conductive plates is further configured (see annular projecting locations 70, 72, et seq., to extend around and enclose the electromagnetic plates 60-68 to define an inner cylindrical chamber within the outer chamber in which all of the conductive plates are configured as individual disk packages which rotate in unison relative to the static/fixed position defined by the electromagnetic plates 30-38, and which are again mounted to the central sleeve support 18.

A blower style motor 74 or like rotational inducing component is provided with an extending stem or rotating shaft 76 (see also direction of rotation 77), the shaft in turn being anchored to a first location 78 for supporting and rotating the elongated conductive element (56/58) proximate to the location of the motor. The shaft 76 is further supported in a journaled or channeled fashion at one or more additional rotational support locations, such as depicted at 80 in order to position and stabilize the elongated conductor plate assembly during rotation relative to the interior arrayed and alternating electromagnetic plates 30-38. In the illustrated embodiment, the motor 74 is static mounted within the interior of the furnace enclosure 10 however it is envisioned that, in future embodiments, the motor can be repositioned outside of the furnace enclosure. Without limitation, the present invention further contemplates the motors described herein being housed in the cabinet so as to capture the heat losses generated by the motor drives, these having been calculated to account for up to 8% of the actual motor power.

The motor 74 is thus configured to rotate the elongated conductive element (see again end wall 56 and outer perimeter wall 58) along with the associated conductive plates 60-68 according to a given rotational speed. This is again necessary to both induce the varying electromagnetic fields to inductive heat the electromagnetic plates 30-38 (with their individual electromagnet arrays) owing to the alternating fields generated by the rotation of the proximate located metallic conductive plates, as well as the air inducing and redirecting architecture of the conductive plate disk packages, these operating to concurrently draw outwardly and redirect the air from the central (cold) inlet, across the magnetic plates in conductive heating fashion, and out an upper end furnace exit 82. It is further envisioned that the present assembly can be applied to any material which is magnetized, such including any of diamagnetic, paramagnetic, and ferromagnetic materials without exemption also referred to as magnetocaloric materials (MEMs).

Additional variables can include varying the designing of the conductive plates, such as not limited varying a thickness, positioning or configuration of a blade or other fluid flow redirecting profile integrated into the conductive plates, as well as utilizing the varying material properties associated with different metals or alloys, such including ferromagnetic, paramagnetic and diamagnetic properties.

A blower door (a portion of which is illustrated at 83 in FIG. 1) is located at the furnace (or alternatively configured refrigerator) exit 82 and, in one non-limiting operating configuration, can remain closed to recirculate the air (or other fluid) within the furnace interior until a desired interior temperature is achieved, at which point the door is opened (see in partial phantom illustration at 83′) to permit heated (or cooled) fluid (in this instance air) to flow from the furnace to the surrounding environment. As further shown, the door can be pivoted or otherwise actuated between the closed 83 and open 83′ positions, such as along directional arrow 84, and through the use of any type of manual or automated hinge or linkage tied into the associated thermostat in order to open the furnace exit at the appropriate time.

One issue encountered with the arrangement of the motor 74 within the interior of the furnace or like housing enclosure is the instance of heat buildup from induction heating adversely affecting motor operation. In an attempt to ameliorate the effects of heat on the motor, the present invention further includes heat dissipation structure incorporated into the fixed axial mounting location depicted by the journal shaft support at 78, and such as is established between the motor extending shaft 76 and the axial supporting location of the conductor plate subassembly (this further again referenced by the mounting support provided again at 78 approximate the central location of end wall 56 of the conductor plate subassembly).

FIGS. 2A-2E (along with corresponding enlarged views FIGS. 2A-1, 2B-1, 2C-1, 2D-1 and 2E-1) depict a variety of motor shaft configurations at the interface location between the shaft and the axial support location established within the conductor plate subassembly. As will be further depicted with each varying example, the shaft configurations each exhibit linear fluid (including air) movement properties in order to assist in dissipating heat generated within the furnace at the shaft support location away from the internally positioned motor 74.

Referencing first FIGS. 2A and 2A-1 a first configuration 82 of the shaft (also at 76 in FIG. 1) is illustrated and includes an intersecting network of radial holes/apertures 84 and crosswise channels 86 which are integrated into the shaft. In this fashion, airflow as depicted at 85 (from ambient air inlet 14) is induced through the shaft interior at the axial mounting interface 78 with the elongated conductive late assembly and, in this fashion, serves to dissipate inductive generated heat at that location through the connection interface 78 and through the open rear exterior of the furnace housing, this in order to minimize the heat profile exerted upon the interior supported motor 74.

FIGS. 2B and 2B-1 illustrate a second configuration 88 of the shaft, in this instance exhibiting a pair of continuous spiraling channels (see at 90), these separated by spiraling outer ridges, further at 92, 94 and 96 in order to induce the ambient fluid inlet flow patterns 97 in a continuous stream through the spiraling channels and to counteract the heat profile created by the rotation of the conductive element/disk packages relative to the electromagnetic plates from adversely impacting the motor 74.

FIGS. 2C and 2C-1 illustrates a further version 98 of shaft which includes an outer insulation jacket or layer 100 to assist in preventing heat emanation from the shaft reaching the fan mounting area (see again at 78). As further best shown in FIG. 2C-1, the insulation jacket 100 exhibits a generally cylindrical or sleeve shape which can also be integrated into the shaft construction, again at 98, so that a flush interface 101 exists between each opposing edge location of the insulating jacket 100 and shaft 98.

FIGS. 2D and 2D-1 depict a further version 102 of shaft with both circumferential outer slotted configurations 104 and intersecting surface exposed linear or axial slots 106, these in combination providing the desired airflow through the shaft in a direction away from the motor.

FIGS. 2E and 2E-1 depict a still further version 108 of a squirrel fan mount and which includes both linear extending and circumferentially spaced louver style mounts 110 and adjoining linear recess profiles 112 in the rotating shaft to assist in creating a constant heat dissipating profile in a direction away from the motor (see directional arrows 113).

In each variant illustrated, the shaft is depicted at a channeled location (again at 80 in the example of FIG. 1) and so that the motor can define an interior powered component which rotatably drives the conductive element and further such that the channeled interior 18 of the sleeve is reserved for drive componentry, with the ambient fluid inlet 14 being communicated to an exterior location of the central sleeve 18 between the sleeve and the individual outer disk shaped location of each of the electromagnetic plates/disk package (corresponding again to axial passage through the radial ribs 40 supporting each outer electromagnetic circular/disk shaped plate).

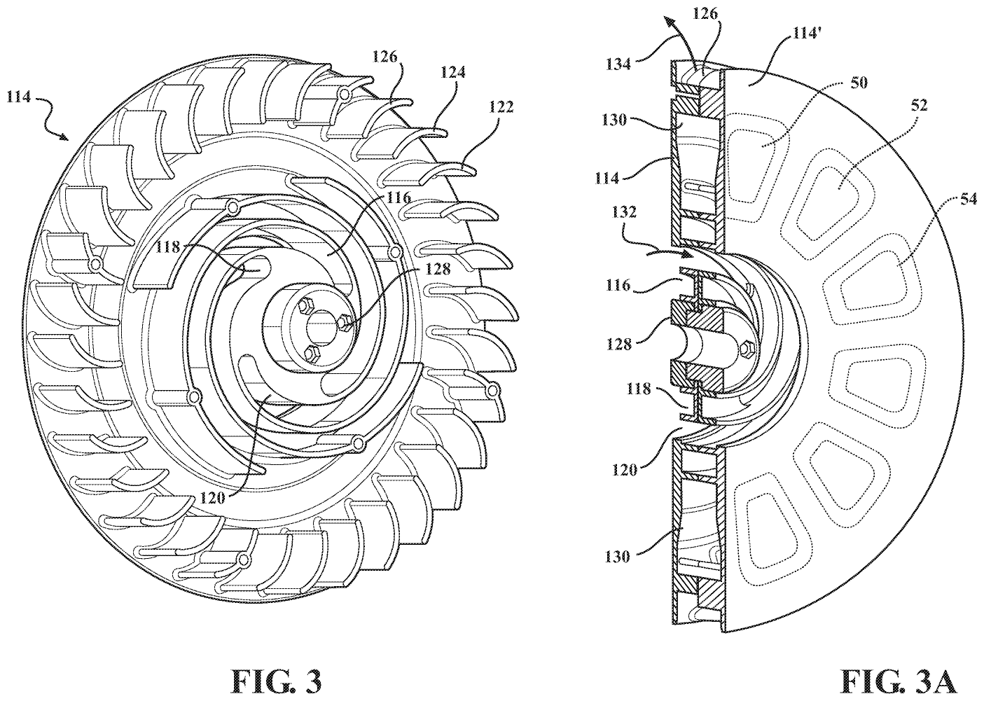

Referring now to FIG. 3, a cutaway taken along line 3-3 of FIG. 1 and illustrating an interior surface profile of a selective conductive plate 114 according to one non-limiting variant of the present invention. The plate 114 includes an inner fluid delivery port in the shape of a plurality of outwardly spiraling patterns 116, 118, 120 which are in communication with the axial intake flow of the cold air inlet 14, the spiraling patterns provided in combination with outer channeling and redirecting vanes 122, 124, 126, et seq. these being arcuate in individual shape and arranged in extending fashion from outer circumferential locations of the plate. In combination with the other features of the plate 114, the vanes operate during rotation of the conductive element (collectively defining all of the spaced conductive plates), to outwardly influence (push) the inductive heated air or other fluid generated from the oscillating fields between the electromagnetic plates and the conductor plates, and resulting from the rotation of the conductive plates 60-68 to influence the conditioned (heated or cooled) fluid, upwardly and out through the top of the furnace cabinet or housing (this again further depicted by outlet 82 in each of FIG. 1 arranged at an upper location of the furnace, heat pump or refrigerator cabinet 12).

The conductive plate 114 (as well as the corresponding disk package of FIG. 3A which combines to opposing plates 114 and 114′ defining an interior package space dictated by the arrangement of the central and outwardly spiraling patterns 116, 118, 120 and the outer vanes 122, 124, 126, et seq.,) can include such as is shown which corresponds to the end plate 68 in FIG. 1 and which also includes a central collar mount 128 is affixed to the shaft 78 (as well as those shown in the alternating variants of FIGS. 2A-2E). As also concurrently viewed from FIG. 1, the axially spaced conductor plates can also include an open center (see also as shown at 60, 62, 64 and 66 in FIG. 1) dimensioned to accommodate the central sleeve support 18 of the fixed magnetic plate subassembly, and so that the conductor plates/disk packages surrounding the central sleeve support 18 are interconnected via their outer interconnecting locations 70, 72 which overlap the individual fixed magnetic plates 30-38.

Reconciling the partial cutaway illustration of the conductive plate location in FIG. 3 with the overall depiction of the conductive element in FIG. 1 and its rotational inter-relationship with the fixed sleeve 18 and electromagnetic plates 30-38, it is understood that the arrangement and dimensioning of the central delivery port 60 in each conductive plate 46-54 can be dimensioned to either seat within or surround the central sleeve 18 of the electromagnetic plate subassemblies.

To this end, the sleeve 18 can be aperture or sectioned, in part or in whole, at locations which coincide with the arrangement of the individual conductive plates 60-68. The present invention further contemplates the fluid inlet being separate from the electromagnetic plate support sleeve 18 and by which the ambient fluid (e.g. air) admittance is provided a location between the outside of the sleeve 18 and the open interior of the electromagnetic plates as separated by the radial rib supports 40 (see also again FIG. 1).

FIG. 3A is a further radial cutaway illustrating in perspective a half section of an assembly of a disk package assembly of conductor plates 114 and 114′, these again depicted in opposing sandwiched arrangement and in order to better show the interior package space for concurrently inductive heating or cooling and outwardly directing the conditioned fluid (e.g. air). As also shown, a circumferential interior pocket 130 is provided between the inner centrifugal spiraling patterns 116/118/120 and the outer circumferential vane patterns 122, 124, 126, et. seq., this providing additional interior space for convective heating or cooling of the air or fluid being channeled through the conductor plate package interior (see interior inlet location 132 outlet discharge 134) and outer resulting from inductive heating by rotation of the disk packages (114/114′) relative to the electromagnetic plates. Also depicted in phantom in FIG. 3A is the arrangement of magnet plate supported electromagnets 50, 52, 54, et seq., which are spaced externally and in proximity to each opposite surface off the sandwiched conductor plates 114/114′, in corresponding fashion to as shown in FIG. 1 in relation to represented plate 60, and in this fashion defining the inductive heating zone between the electromagnetic plates and opposing spaced conductor plates, the latter further including the spiraling airflow inducing patterns 116-120, along with the interior circular pocket 130 and the outer vanes 122, 124, 126, et. seq. for assisting in redirecting the conditioned fluid to the housing outlet 82.

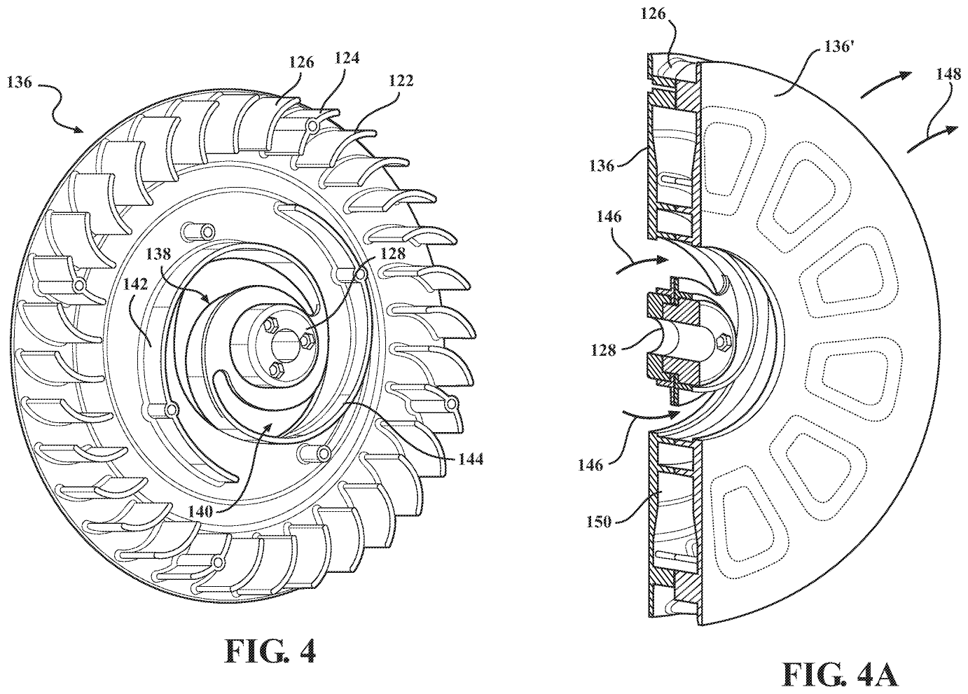

Proceeding to FIGS. 4-4A, illustrated are a pair of cutaway views corresponding to FIGS. 3-3A of a further variant of conductor plate (see at 136 in FIG. 4) and assembled disk package (assembled plates 136/136′) exhibiting a radially spiraling double flute configuration, this being further depicted by outwardly spiraling channels 138/140 and flow defining outer spiraling walls 142/144. A similar arrangement of outer circumferential spaced and surface projecting vanes are again provided at 122, 124, 126, et seq., and which, upon assembling together a pair of the plates 136/136′ into a disk package (FIG. 4A) provide targeted air redirection (see central inlet arrows 146 and outlet arrows 148) during rotation of the conductor plate packages proximate to the alternating positioned and electromagnet supporting electromagnetic or magnetic plates. The configuration of FIGS. 4-4A further depicts an enlarged inner circular pocket 150 which generally aligns with the proximately located electromagnet array in order to focus inductive heating within the conductor plate package during rotation of the disk package assembly provided by each sandwiched pair of plates.

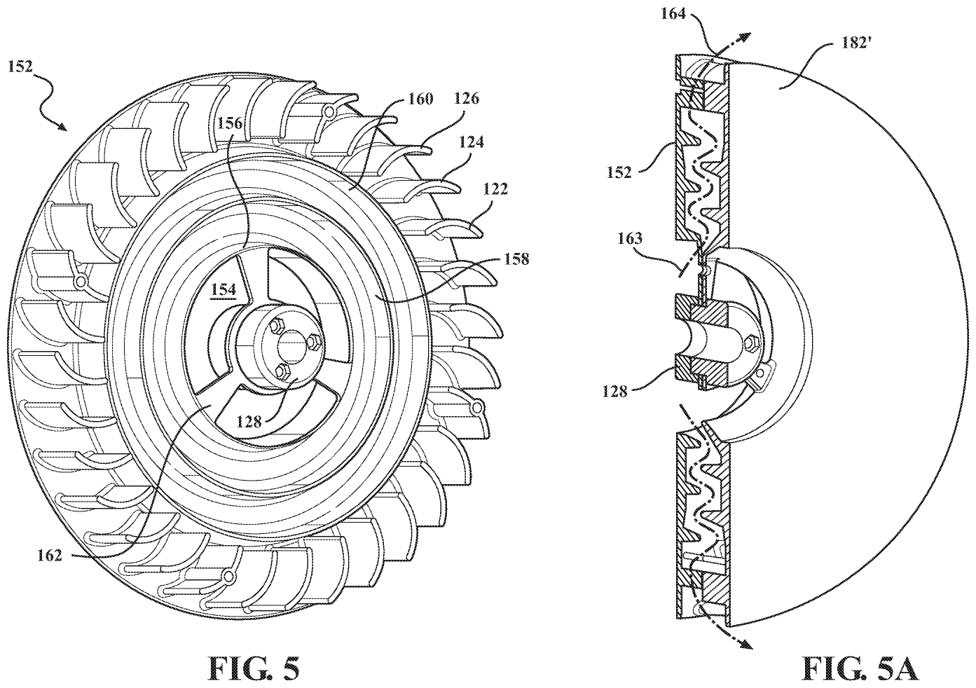

FIGS. 5-5A further illustrate a pair of cutaway views corresponding to FIGS. 3-3A of another variant of conductor plate (at 152 in FIG. 5) and assembled disk package (pair of opposing and sandwich assembled plates 152/152′) and in which each plate exhibits a baffled heat chamber configuration. Referring to FIG. 5, the selected plate 152 depicts an open center 154 for admitting air from the furnace intake and redirecting along circumferential guide walls 156, 158, 160 before redirecting outwardly in an arcuate discharge along a similar circumferential vane pattern 122, 124, 126, et seq. Inner radial supports (see at 162) are circumferentially spaced between the inner central axial mount 128 and the outer inductive heating and airflow redirecting patterns. FIG. 5A further depicts the centrifugal induced travel of the inductive heated fluid (e.g. air) flow between an inner inlet location 163 and an outermost exit location 164.

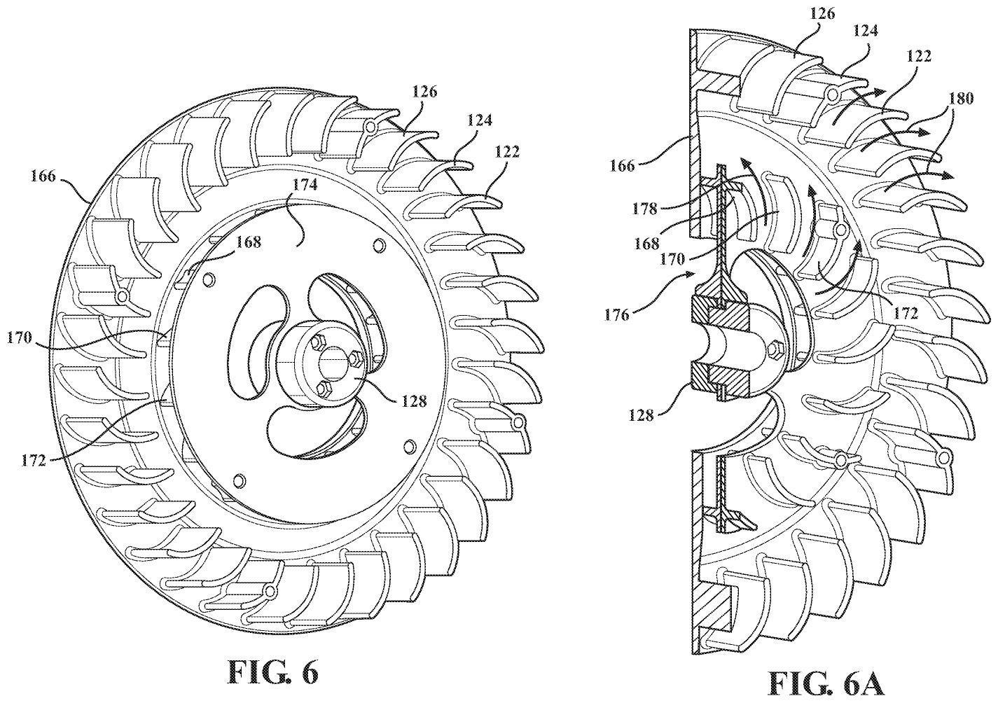

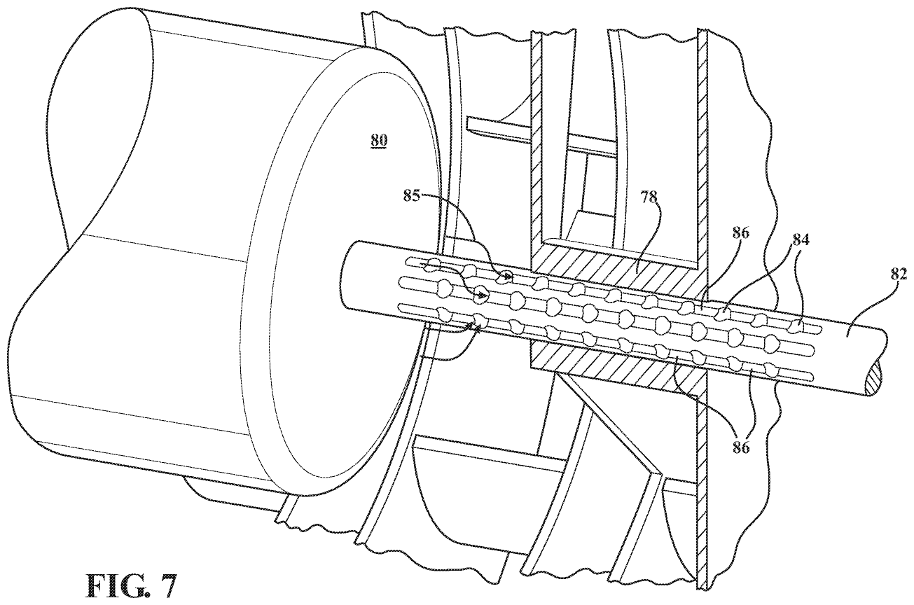

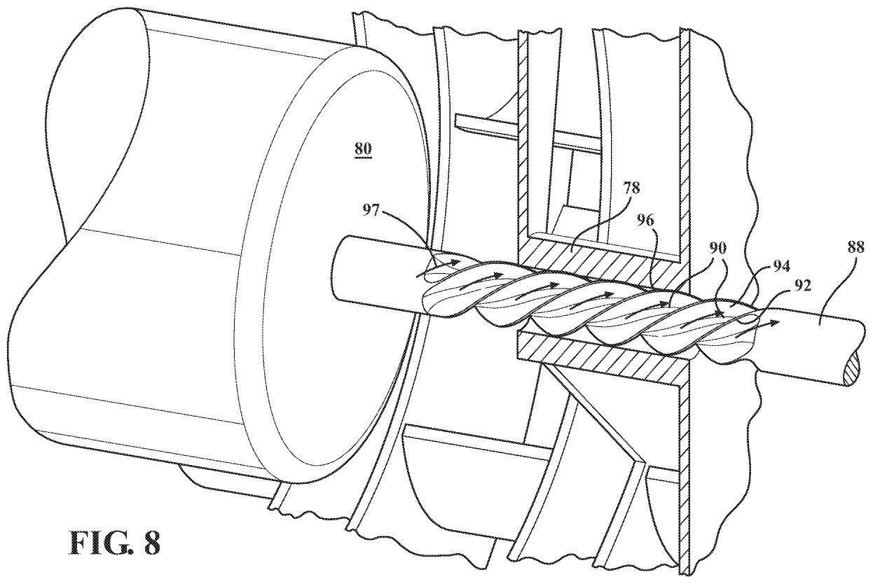

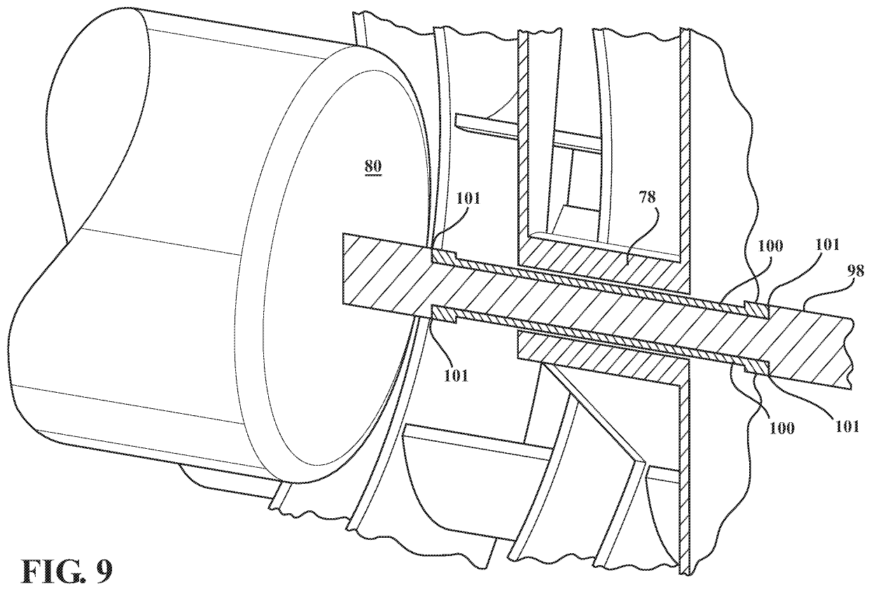

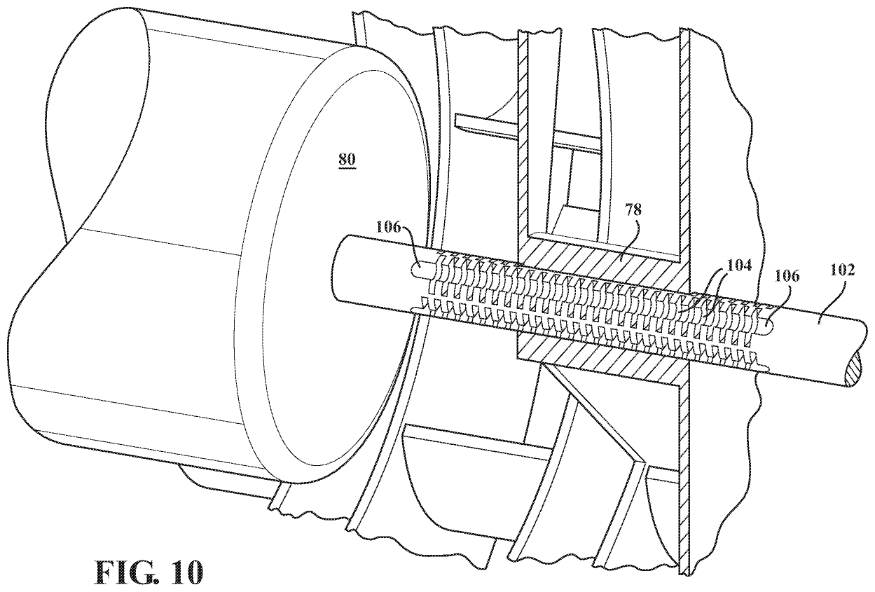

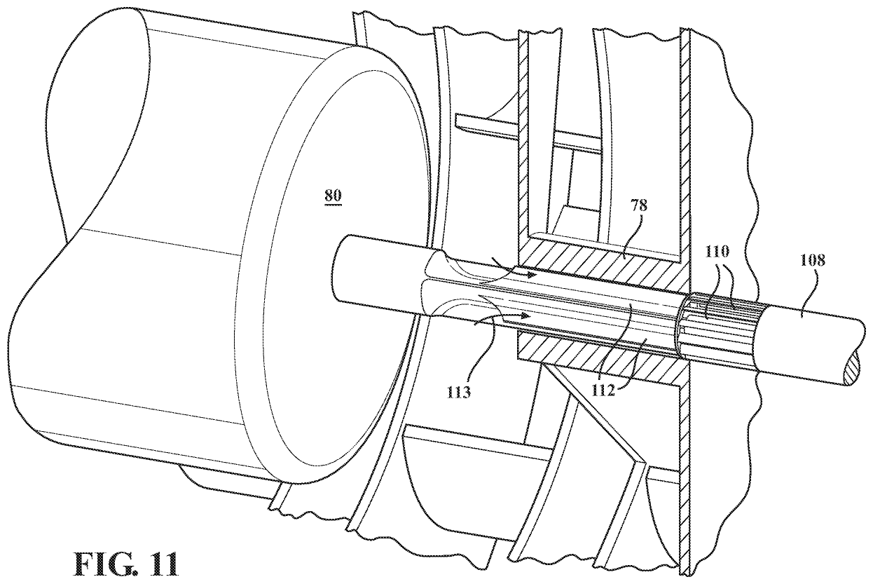

Finally, FIGS. 6-6A depict are a pair of cutaway views corresponding to FIGS. 3-3A of a still further variant of conductor plate at 166 which is redesigned to include a radially inner arrangement of redirecting vanes 168, 170, 172, et seq., in addition to the outer circumferential vane pattern as again depicted at 122, 124, 126, et seq. A circular plate or shroud 174 can be provided for covering the inner circumferential vane pattern 168, 170, 172, et seq. Alternatively, the conductive plates could be arranged in a similar disk package configuration, such as with the shroud 174 supporting inn circumferential vane patterns on both sides.

As with the previous embodiments, the vane patterns associated with the conductive plates can be configured in any shape or pattern to facilitate redirection of the inductive heated airflow from a central inlet location (arrows 176), interior redirecting location (arrows 178 across inner vane pattern), and outwardly (arrows 180 across second reversing vane pattern) in the manner illustrated in FIG. 6A and in order to enhance both the inductive heating profile as well as the centrifugal discharge of the airflow from the outer perimeter of the rotating conductive plate and through the furnace, heat pump or magnetic refrigerator exit location 82.

Other and additional envisioned applications of the present technology can include adapting the present technology for use in magnetic heat pump (MHG) applications or magnetic refrigerators (MR), such utilizing a magneto-caloric effect (MCE) provide either of heating or cooling properties resulting from the magnetization (heat) or demagnetization (cold) cycles. The goal in such applications is to achieve a coefficient of performance (defined as a ratio of useful heating or cooling provided to work required) which is greater than 1.0. In such an application, the system operates to convert work to heat as well as additionally pumping heat from a heat source to where the heat is required (and factoring in all power consuming auxiliaries). As is further known in the relevant technical art, increasing the COP (such as potentially to a range of 2.0-3.5 or upwards) further results in significantly reduced operating costs in relation to the relatively small input electrical cost required for rotating the conductive plate(s) relative to the magnetic plate(s). Such magnetic refrigeration techniques result in a cooling technology based on the magneto-caloric effect and which can be used to attain extremely low temperatures within ranges used in common refrigerators.

As is further known in the relevant technical art, the magneto-caloric effect is a magneto-thermodynamic phenomenon in which a temperature change of a suitable material is again caused by exposing the material to a changing magnetic field, such being further known by low temperature physicists as adiabatic (defined as occurring without gain or loss of heat) demagnetization. In that part of the refrigeration process, a decrease in the strength of an externally applied magnetic field allows the magnetic domains of a magneto-caloric material to become disoriented from the magnetic field by the agitating action of the thermal energy (phonons) present in the material.

If the material is isolated so that no energy is allowed to (re)migrate into the material during this time, (i.e., again the adiabatic process) the temperature drops as the domains absorb the thermal energy to perform their reorientation. The randomization of the domains occurs in a similar fashion to the randomization at the curie temperature of a ferromagnetic or paramagnetic material, except that magnetic dipoles overcome a decreasing external magnetic field while energy remains constant, instead of magnetic domains being disrupted from internal ferromagnetism (or paramagnetism) as energy is added. Applications of this technology can include, in one non-limited application, the ability to heat a suitable alloy arranged inside of a magnetic field as is known in the relevant technical art, causing it to lose thermal energy to the surrounding environment which then exists the field cooler than when it entered.

Other envisioned applications include the ability to generate heat utilizing either individually or in combination rare earth magnets placed into a high frequency oscillating magnetic field as well as static electromagnetic field source systems including such as energized electromagnet assemblies which, in specific instances, can be combined together within a suitable assembly not limited to that described and illustrated herein and for any type of electric induction, electromagnetic and magnetic induction application.

Additional features may include the ability to configure turbine blades as magnetized elements that can generate heat or cold. It is further envisioned that the present assembly can be applied to any material which is magnetized, such including any of diamagnetic, paramagnetic, and ferromagnetic materials without exemption also referred to as magnetocaloric materials (MEMs).

Additional factors include the ability to reconfigure the assembly so that the frictionally heated fluid existing between the overlapping magnetic and rotating conductive plates may also include the provision of additional fluid mediums (both gaseous and liquid state) for better converting the heat or cooling configurations disclosed herein.

Other envisioned applications can include the provision of capacitive and resistance (ohmic power loss) designs applicable to all materials/different configurations as disclosed herein.

The present invention also envisions, in addition to the assembly as shown and described, the provision of any suitable programmable or software support mechanism, such as including a variety of operational modes. Such can include an Energy Efficiency Mode: step threshold function at highest COP (at establish motor drive rpm) vs Progressive Control Mode: ramp-up curve at different rpm/COPs).

Given the above description, the present invention additionally envisions numerous techniques, teachings and factors for modifying the temperature range of heating or cooling which can be accomplished for the variants described herein. This can include modifying the rotational speed (such as measured in RPM' s or revolutions per minute) of the conductive plates, thereby affecting the magnetic or electromagnetic induction (magnetic field created) and, consequently, adjusting the eddy currents created in the conductive plates. With higher rotation the oscillating high frequencies of the magnetic/electromagnetic induction increases the temperature in the case of heating and also creates higher demagnetization forces (once the magnetic/electromagnetic induction is “off”) that can absorb more heat if exposed to a fluid flow (in the case of inductive cooling).

Other heat/cooling adjustment variables can involve modifying the degree of magnetic friction created, such as by varying the distance between the conductive plates and alternating arranged magnetic/electromagnetic plates. A further variable can include limiting the exposure of the conductive fluid (gas, liquid, etc.,) to the conductive component, such that a no flow condition may result in raising the temperature (and which can be controllable for certain periods of time).

As is further generally understood in the technical art, temperature is limited to Curie temperature, with magnetic properties associated with losses above this temperatures. Accordingly, rare earth magnets, including such as neodymium magnets, can achieve temperature ranges upwards of 900° C. to 1000° C.

Ferromagnetic Materials, such as again which can be integrated into the conductive plates, can include any of Iron (Fe) having a Curie temperature of 1043K (degrees Kelvin), Cobalt (Co) having a Curie temperature of 1400K, Nickel (Ni) having a Curie temperatures of 627K and Gadolinium (Gd) having a Curie temperature of 292K.

According to these teachings, Curie point, also called Curie Temperature, defines a temperature at which certain magnetic materials undergo a sharp change in their magnetic properties. In the case of rocks and minerals, remanent magnetism appears below the Curie point—about 570° C. (1,060° F.) for the common magnetic mineral magnetite. Below the Curie point—by non-limiting example, 770° C. (1,418° F.) for iron—atoms that behave as tiny magnets spontaneously align themselves in certain magnetic materials.

In ferromagnetic materials, such as pure iron, the atomic magnets are oriented within each microscopic region (domain) in the same direction, so that their magnetic fields reinforce each other. In antiferromagnetic materials, atomic magnets alternate in opposite directions, so that their magnetic fields cancel each other. In ferromagnetic materials (this defined as the pertaining to a substance such as ferrite in which the magnetic moments of some neighboring atoms point in opposite directions, with a net magnetization still because of differences in magnitudes of the opposite moments), the spontaneous arrangement is a combination of both patterns, usually involving two different magnetic atoms, so that only partial reinforcement of magnetic fields occurs.

As a further subset teaching, paramagnetic cooling can be simply described as employing materials that cannot be pulled by the magnet”. When a paramagnetic material is cooled excessively, the heat transfer of its molecules is reduced, as in other materials.

As a related teaching, magnetic cooling also exploits the relationship between the effects of the magnetic field strength of an applied field and the entropy of an object. One particular method of magnetic cooling is Adiabatic Demagnetization, which capitalizes on the paramagnetic properties of some materials to cool those materials (usually in gaseous form) down into the milli-Kelvin—or colder—range. This method can also be used to cool solid objects, but the most drastic cooling in the fractions of a kelvin range are generally accomplished for low-density gases that have already been greatly cooled (around 3-4 K).

The process of Adiabatic Demagnetization can include a sample first being cooled (typically a gas) and allowed to touch a cold reservoir (which has a constant temperature of around 3-4 degrees Kelvin, and is often liquid Helium), at which point a magnetic field is induced in the region of the sample. Once the sample is in thermal equilibrium with the cold reservoir, the magnetic field strength is increased, resulting in the entropy of the sample decreasing and as the system becomes more ordered as particles align with the magnetic field. While this is occurring, the temperature of the sample is still the same as that of the cold reservoir.

The sample is then isolated from the cold reservoir, and the magnetic field strength is reduced. At this point, the entropy of the sample remains the same, but its temperature drops in reaction to the reduction in the magnetic field strength. If the sample was already at a fairly low temperature, this temperature decrease can be ten-fold or greater. Repeating the process results in the sample being cooled to very low temperatures.

Given the above, raising the temperature to the Curie point for any of the materials in these three classes entirely disrupts the various spontaneous arrangements, and only a weak kind of more general magnetic behavior, called paramagnetism, remains. As is further known, one of the highest Curie points is 1,121° C. (2,050° F.) for cobalt. Temperature increases above the Curie point produce roughly similar patterns of decreasing paramagnetism in all three classes of materials such that, when these materials are cooled below their Curie points, magnetic atoms spontaneously realign so that the ferromagnetism, antiferromagnetism, or ferrimagnetism revives. As is further known, the antiferromagnetic Curie point is also referenced as the Néel temperature.

Beyond the instant disclosure, other factors or variable controlling the temperature output can include the strength of the magnets or electromagnets which are incorporated into the plates, such as again by selected rare earth magnets having varying properties or, alternatively, by adjusting the factors associated with the use of electromagnets including an amount of current through the coils, adjusting the core ferromagnetic properties (again though material selection) or by adjusting the cold winding density around the associated core.

Other temperature adjustment variables can include modifying the size, number, location and orientation of the assemblies (elongated and plural magnet/electromagnet and alternative conductive plates). Multiple units or assemblies can also be stacked, tiered or otherwise ganged in order to multiply a given volume of conditioned fluid which is produced.

Additional variables can include varying the designing of the conductive plates, such as not limited varying a thickness, positioning or configuration of a blade or other fluid flow redirecting profile integrated into the conductive plates, as well as utilizing the varying material properties associated with different metals or alloys, such including ferromagnetic, paramagnetic and diamagnetic properties.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

I claim:

1. An electromagnetic induction system for providing either of heating or cooling, comprising:
a housing having a fluid inlet;
a sleeve shaped support extending within said housing;
a plurality of spaced apart electromagnetic plates communicated with said inlet, said plates extending radially from said sleeve support,
an elongated conductive component rotatably supported about said sleeve support, said conductive component incorporating a plurality of linearly spaced apart and radially projecting conductive plates which alternate with said axially spaced and radially supported electromagnetic plates;
a motor for rotating said conductive component in order to generate an oscillating magnetic field relative to said electromagnetic plates, resulting in conditioning of the fluid by either heating or cooling of the fluid;
a controller adjusting an intensity of the magnetic fields in order to adjust a level of conditioning of the fluid produced by rotation of said conductive component; and
said conductive component communicating the conditioned fluid through an outlet of said housing.

2. The invention of claim 1, further comprising a shaft extending from said motor to said conductive component, said shaft being configured to dissipate heat generated within said conductive component at a mounting location with said shaft.

3. The invention as described in claim 2, further comprising said shaft being configured to induce a heat dissipating or cold fluid airflow through the mounting location to an external location of said housing.

4. The invention as described in claim 2, said shaft further comprising a grid of air passageway inducing and intersecting radial and axial channels.

5. The invention as described in claim 2, said shaft further comprising a spiraling pattern.

6. The invention as described in claim 2, said shaft further comprising a squirrel fan having a plurality of axial extending louvers within the mounting location.

7. The invention of claim 1, further comprising each of said conductive plates being arranged as a pair of opposing plates assembled into a disk package and defining an interior fluid flow influencing an outwardly spiraling pattern.

8. The invention of claim 7, each of said conductive plates further comprising an outer circumferential array of channeling and redirecting vanes for pushing the inductive heated air through said outlet.

9. The invention as described in claim 8, further comprising a second and inner circumferential array of channeling and redirecting vanes for pushing the inductive heated air through from said inlet to said outer array of redirecting vanes.

10. The invention as described in claim 1, further comprising brackets extending from said sleeve to end mounting locations within said housing, a cylindrical outer wall extending between said mounting locations to define an outer cylindrical chamber surrounding said electro-magnetic plates.

11. The invention as described in claim 10, said conductive component further comprising end walls and an interconnecting second cylindrical wall interconnecting each of said conductive plates and extending around said electro-magnetic plates to define an inner cylindrical chamber within said outer cylindrical chamber.

12. The invention as described in claim 1, further comprising a thermostat in communication with said controller and operating in a first mode for adjusting the intensity of the electro-magnetic fields, said controller operating in a second mode to turn said electromagnets off in order to operate in a fan mode.

13. The invention as described in claim 1, each of said electro-magnetic plates further comprising an individual sub-plurality of electromagnets arranged about a circumference thereof.

14. An electromagnetic induction heating system, comprising:
a housing having a fluid inlet;
a sleeve shaped support extending within said housing;
a plurality of spaced apart electromagnetic plates communicated with said inlet, said plates extending radially from said sleeve support and each integrating a sub-plurality of electromagnets arranged around a circumference thereof, an elongated conductive component rotatably supported about said sleeve support, said conductive component incorporating a plurality of linearly spaced apart and radially projecting conductive plates which alternate with said axially spaced and radially supported electromagnetic plates;
a motor for rotating said conductive component in order to generate an oscillating magnetic field relative to said electromagnetic plates, resulting in heating of the fluid;
a controller adjusting an intensity of the magnetic fields in order to adjust a level of heating of the fluid flow produced by rotation of said conductive component; and
said conductive component communicating the conditioned fluid through an outlet of said housing.

15. The invention as described in claim 14, further comprising a thermostat in communication with said controller and operating in a first mode for adjusting the intensity of the electro-magnetic fields, said controller operating in a second mode to turn said electromagnets off in order to operate in a fan mode.

16. The invention of claim 14, further comprising a shaft extending from said motor to said conductive component, said shaft being configured to dissipate heat generated within said conductive component at a mounting location with said shaft.

17. The invention as described in claim 16, further comprising said shaft being configured to induce a heat dissipating airflow through the mounting location to an external location of said housing.

18. The invention of claim 14, further comprising each of said conductive plates being arranged as a pair of opposing plates assembled into a disk package and defining an interior airflow influencing an outwardly spiraling pattern along with an outer circumferential array of channeling and redirecting vanes for pushing the inductive heated air through said outlet.

19. The invention as described in claim 18, further comprising a second and inner circumferential array of channeling and redirecting vanes for pushing the inductive heated air through from said inlet to said outer array of redirecting vanes.

20. An electromagnetic induction heating or cooling system, comprising:
a housing having a fluid inlet;
a sleeve shaped support extending within said housing;
a plurality of spaced apart magnetic plates communicated with said inlet, said plates extending radially from said sleeve support and each integrating a sub-plurality of electromagnets arranged around a circumference thereof,
an elongated conductive component rotatably supported about said sleeve support, said conductive component incorporating a plurality of linearly spaced apart and radially projecting conductive plates which alternate with said axially spaced and radially supported magnetic plates;
a motor for rotating said conductive component in order to generate an oscillating magnetic field relative to said magnetic plates, resulting in heating of the fluid;
a shaft extending from said motor to said conductive component, said shaft being configured to dissipate heat generated within said conductive component at a mounting location with said shaft;
a controller adjusting an intensity of the magnetic fields in order to adjust a level of heating of the fluid flow produced by rotation of said conductive component; and
said conductive component communicating the conditioned fluid through an outlet of said housing.
